(19) United States
(12) Patent Application Publication
(10) Pub. No.: US 2006/0119590 A1
(43) Pub. Date: Jun. 8, 2006

(54) Touch sensible display device and driving method thereof

(76) Inventors: Jong-Woung Park, Seongnam-si (KR); Hyung-Guel Kim, Yongin-si (KR); Kee-Han Uh, Yongin-si (KR); Joo-Hyung Lee, Gwacheon-si (KR)

Correspondence Address: CANTOR COLBURN, LLP, 55 GRIFFIN ROAD SOUTH, BLOOMFIELD, CT, 06002, US

(21) Appl. No.: 11/285,923

(22) Filed: Nov. 22, 2005

(30) Foreign Application Priority Data
Nov. 22, 2004 (KR) 10-2004-0095791

(51) Int. Cl. G09G 5/00

(52) U.S. Cl. 345/175

(57) ABSTRACT

A display device includes a first photosensor receiving ambient light and generating a first sensing signal based on a first amount of received light, a touch photosensor exposed to the ambient light and generating a second sensing signal based on a second amount of received light, and a sensing signal processor receiving the first sensing signal and the second sensing signal and selectively outputting the second sensing signal based on the first sensing signal.

This application claims priority to Korean Patent Application No. 10-2004-0095791, filed on Nov. 22, 2004 and all the benefits accruing therefrom under 35 U.S.C. §119, and the contents of which in its entirety are herein incorporated by reference.

### BACKGROUND OF THE INVENTION

(a) Field of the Invention

The present invention relates to a display device and a driving method thereof. More particularly, the present invention relates to a touch sensible display device and a driving method thereof.

(b) Description of the Related Art

A liquid crystal display (“LCD”) includes a first panel provided with pixel electrodes and a second panel provided with a common electrode. A liquid crystal layer with dielectric anisotropy is interposed between the first and second panels. The pixel electrodes are arranged on the first panel in a matrix and are connected to switching elements such as thin film transistors (“TFTs”) such that they receive image data voltages row by row. The common electrode covers an entire surface of the second panel and is supplied with a common voltage. A pixel electrode and corresponding portions of the common electrode, and corresponding portions of the liquid crystal layer form a liquid crystal capacitor that, in addition to a switching element connected thereto, is a basic element of a pixel.

An LCD generates electric fields by applying voltages to pixel electrodes and a common electrode and varies the strength of the electric fields to adjust the transmittance of light passing through the liquid crystal layer, thereby displaying images.

Recently, an LCD incorporating photosensors has been developed. The photosensors sense the change of incident light caused by a touch of a finger or a stylus and provide electrical signals corresponding thereto for the LCD. The LCD processes the electrical signals from the photosensors and outputs the processed signals to an external device. The external device determines whether and where a touch exists on a display panel of the LCD based on the processed electrical signals and may return image signals to the LCD, which are generated based on the information.

The external device is required to process a large number of two dimensional data included in the processed electrical signals in a short time period for correctly determining the touch information. For example, the external device needs to process a frame of data in 16.6 ms when the sensing frequency of the photosensors is equal to 60 Hz. Although the processing speed may be improved by employing a high-performance processor, such a processor may increase the manufacturing cost. The processing time can be decreased by reducing the resolution of the photosensors, but the reduction of resolution of the photosensors may decrease the precision of the determination of a touched position. In the meantime, the sensing frequency of the photosensors may be reduced to increase the time for processing a frame data, but reducing the sensing frequency of the photosensors may decrease the sensitivity in sensing cursive letters.

### BRIEF SUMMARY OF THE INVENTION

Exemplary embodiments of a display device according to the present invention include a first photosensor receiving ambient light and generating a first sensing signal based on a first amount of received light, a touch photosensor exposed to the ambient light and generating a second sensing signal based on a second amount of received light, and a sensing signal processor receiving the first sensing signal and the second sensing signal and selectively outputting the second sensing signal based on the first sensing signal.

The sensing signal processor may output the second sensing signal when the second amount of received light is different from the first amount of received light by a value larger than a first predetermined value.

The sensing signal processor may output the second sensing signal when the second sensing signal is different from the first sensing signal by a value larger than a second predetermined value.

The sensing signal processor may output an output signal having a third predetermined value when the second sensing signal is equal to the first sensing signal or is different from the first sensing signal by a value smaller than the second predetermined value.

Exemplary embodiments of a display device according to the present invention include a first photosensor receiving ambient light and equipped light and generating a first sensing signal based on an amount of received light, a second photosensor blocked from ambient light, receiving the equipped light, and generating a second sensing signal based on an amount of received light, a touch photosensor receiving the ambient light and the equipped light and generating a third sensing signal based on an amount of received light, and a sensing signal processor receiving the first, second, and third sensing signals and selectively outputting the third sensing signal based on the first and the second sensing signals.

The sensing signal processor may generate a first reference signal based on one of the first sensing signal and the second sensing signal, and may generate a second reference signal based on the other of the first sensing signal and the second sensing signal. The second reference signal is smaller than the first reference signal. The sensing signal processor may output the third sensing signal when the third sensing signal has a value between the first reference signal and the second reference signal.

The sensing signal processor may output an output signal having a predetermined value when a value of the third sensing signal is out of a range between the first reference signal and the second reference signal.

The output signal of the sensing signal processor may be zero when the value of the third sensing signal is out of a range between the first reference signal and the second reference signal.

The first and the second reference signals may be determined by adding or subtracting a predetermined value from the first and the second sensing signals. The first and the second reference signals may be determined so that the second sensing signal lies between the first reference signal and the second reference signal.

The sensing signal processor may include a calculator generating the first and the second reference signals and a comparison unit generating an output signal having a first level and a second level, wherein the output signal of the comparison unit has the first level when the third sensing signal lies between the first reference signal and the second reference signal and has the second level when the third sensing signal lies outside of a range between the first reference signal and the second reference signal.

The comparison unit may include a first comparator having a non-inverting terminal supplied with the first reference signal and an inverting terminal supplied with the third sensing signal and a second comparator having a non-inverting terminal supplied with the third sensing signal and an inverting terminal supplied with the second reference signal.

The first and the second comparators may have a common output.

The sensing signal processor may further include an analog-to-digital converter converting the first sensing signal, the second sensing signal, and the third sensing signal into a first digital sensing signal, a second digital sensing signal, and a third digital sensing signal, respectively, and a digital-to-analog converter connected between the calculator and the comparison unit and analog converting the first and the second reference signals supplied from the calculator.

The sensing signal processor may further include a sensing signal regulator parallel-to-serial converting the first to the third sensing signals to be applied to the analog-to-digital converter.

The sensing signal processor may further include an output unit selectively outputting the third sensing signal in response to the output signal of the comparison unit.

The output unit may include a plurality of AND gates and each of the AND gates may have a first input terminal coupled with an output terminal of the analog-to-digital converter and a second input terminal supplied with the output signal of the comparison unit.

The output unit may output the third sensing signal when the output signal of the comparison unit has the first level and may output a predetermined value when the output signal of the comparison unit has the second level.

The output unit may output a zero value as the predetermined value when the output signal of the comparison unit has the second level.

The display device may further include a plurality of pixels displaying images and disposed in a display area, wherein the first photosensor and the touch photosensor are disposed in the display area and the second photosensor is disposed out of the display area.

The first, second, and touch photosensors may include amorphous silicon or polysilicon thin film transistors.

Exemplary embodiments of a method of processing sensing signals of a display device according to the present invention include generating a first sensing signal based on ambient light and equipped light, generating a second sensing signal based on the equipped light, generating a third sensing signal based on received light according to a touch, and selectively outputting the third sensing signal based on the first and the second sensing signals.

The selective output of the third sensing signal may include generating a first reference signal and a second reference signal lower than the first reference signal based on the first and the second sensing signals, comparing the third sensing signal with the first and the second reference signals, and outputting a signal having a predetermined value when the third sensing signal lies outside of a range between the first reference signal and the second reference signal.

The selective output of a third sensing signal may further include outputting the third sensing signal when the third sensing signal lies between the first reference signal and the second reference signal.

The method may further include determining the first and the second reference signals so that the second sensing signal lies between the first reference signal and the second reference signal.

Exemplary embodiments of a sensing signal processor may include a sensing signal receiving portion receiving at least a first sensing signal, a second sensing signal, and a third sensing signal, a sensing signal extractor converting the first sensing signal and the second sensing signal into first and second reference signals, and an output unit outputting the third sensing signal when the third sensing signal lies between the first and second reference signals, and outputting a constant value when the third sensing signal lies outside a range between the first and second reference signals.

The sensing signal processor may further include a comparison unit within the sensing signal extractor, the comparison unit comparing an output of the sensing signal receiving portion with the first and second reference signals, wherein the comparison unit outputs a first level when the third sensing signal lies between the first and second reference signals, and outputs a second level when the third sensing signal lies outside a range between the first and second reference signals.

The output unit may output the third sensing signal when the output signal of the comparison unit has the first level and outputs the constant value when the output signal of the comparison unit has the second level. The constant value may be zero.

Exemplary embodiments of a display device according to the present invention may include a touch sensing circuit for sensing a touch and outputting a sensing signal, and a sensing signal processor receiving the sensing signal and comparing the sensing signal to first and second reference signals, wherein the sensing signal processor outputs the sensing signal when the sensing signal lies within a range between the first and second reference signals, and outputs a predetermined constant value when the sensing signal lies outside a range between the first and second reference signals.

The display device may further include a first reference sensing circuit and a second reference sensing circuit. The first reference sensing circuit may lie within a display area of the display device, and the second reference sensing circuit may lie outside the display area of the display device.

### BRIEF DESCRIPTION OF THE DRAWINGS

The present invention will become more apparent by describing embodiments thereof in detail with reference to the accompanying drawings in which:

FIG. 1 is a block diagram of an exemplary embodiment of an LCD according to the present invention;

FIG. 2 is an equivalent circuit diagram of an exemplary embodiment of a pixel of an LCD according to the present invention;

FIG. 3 is a layout view of an exemplary embodiment of an LC panel assembly according to the present invention;

FIG. 4 is a sectional view of the LC panel assembly shown in FIG. 3 taken along line IV-IV;

FIG. 5 is a sectional view of the LC panel assembly shown in FIG. 3 taken along line V-V;

FIGS. 6A and 6B are schematic diagrams of exemplary embodiments of reference photo sensing circuits according to the present invention;

FIG. 7 is a schematic diagram of an exemplary LC panel assembly including the reference photo sensing circuits shown in FIGS. 6A and 6B;

FIG. 8 is a block diagram of an exemplary embodiment of a sensing signal processor for an LCD according to the present invention;

FIGS. 9A and 9B are graphs illustrating sensing signals of touch sensing circuits of an exemplary embodiment of an LCD according to the present invention;

FIG. 10 is a graph illustrating input-to-output relation of an exemplary comparison unit shown in FIG. 8;

FIG. 11A shows exemplary output signals of a conventional sensing signal processor, which are arranged in a panel assembly; and

FIG. 11B shows exemplary output signals of the exemplary sensing signal processor shown in FIGS. 8-10, which are arranged in an LC panel assembly.

### DETAILED DESCRIPTION OF THE INVENTION

The present invention now will be described more fully hereinafter with reference to the accompanying drawings, in which preferred embodiments of the invention are shown.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

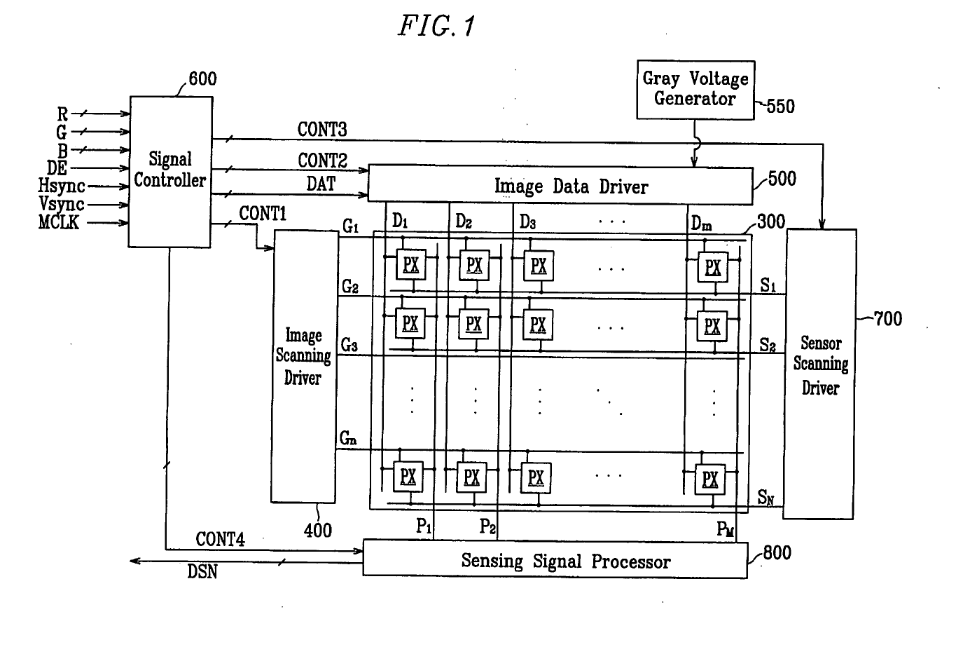

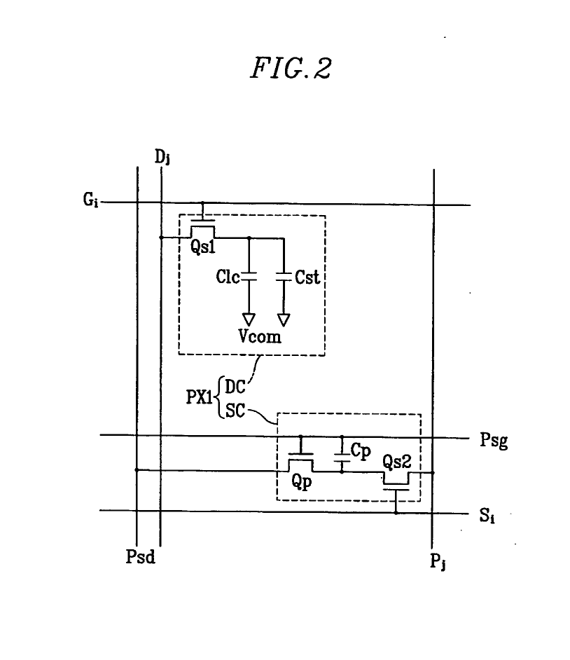

A liquid crystal display (“LCD”) as an example of an exemplary embodiment of a display device according to the present invention will now be described in detail with reference to FIGS. 1 and 2.

FIG. 1 is a block diagram of an exemplary embodiment of an LCD according to the present invention, and FIG. 2 is an equivalent circuit diagram of an exemplary embodiment of a pixel of an LCD according to the present invention.

Referring to FIG. 1, an LCD includes a liquid crystal (“LC”) panel assembly 300, an image scanning driver 400, an image data driver 500, a sensor scanning driver 700, and a sensing signal processor 800 that are coupled with the LC panel assembly 300, a gray voltage generator 550 coupled to the image data driver 500, and a signal controller 600 controlling the above elements.

Referring to FIGS. 1-3, the LC panel assembly 300 includes a lower panel as a thin film transistor (“TFT”) array panel, an upper panel as a common electrode panel, where the upper and lower panels face each other, and a liquid crystal layer 3 interposed there between. The lower panel of the LC panel assembly 300 includes a plurality of display signal lines G₁-Gₙ and D₁-Dₘ a plurality of sensor signal lines S₁-S_{N}, P₁-P_{M}, Psg, and Psd, and a plurality of pixels PX. The pixels PX are connected to the display signal lines G₁-Gₙ and D₁-Dₘ and the sensor signal lines S₁-S_{N}, P₁-P_{M}, Psg and Psd and are arranged substantially in a matrix.

The display signal lines include a plurality of image scanning lines G₁-Gₙ, otherwise known as gate lines, transmitting image scanning signals and a plurality of image data lines D₁-Dₘ transmitting image data signals. The image scanning lines G₁-Gₙ may be insulated from the image data lines D₁-Dₘ.

The sensor signal lines include a plurality of sensor scanning lines S₁-S_{N} transmitting sensor scanning signals, a plurality of sensor data lines P₁-P_{M} transmitting sensor data signals, a plurality of control voltage lines Psg transmitting a sensor control voltage, and a plurality of input voltage lines Psd transmitting a sensor input voltage.

The image scanning lines G₁-Gₙ and the sensor scanning lines S₁-S_{N} extend substantially in a row direction and are substantially parallel to each other, while the image data lines D₁-Dₘ and the sensor data lines P₁-P_{M} extend substantially in a column direction and are substantially parallel to each other. Thus, the image scanning lines G₁-Gₙ and the sensor scanning lines S₁-S_{N} may extend substantially perpendicular to the image data lines D₁-Dₘ and the sensor data lines P₁-P_{M}.

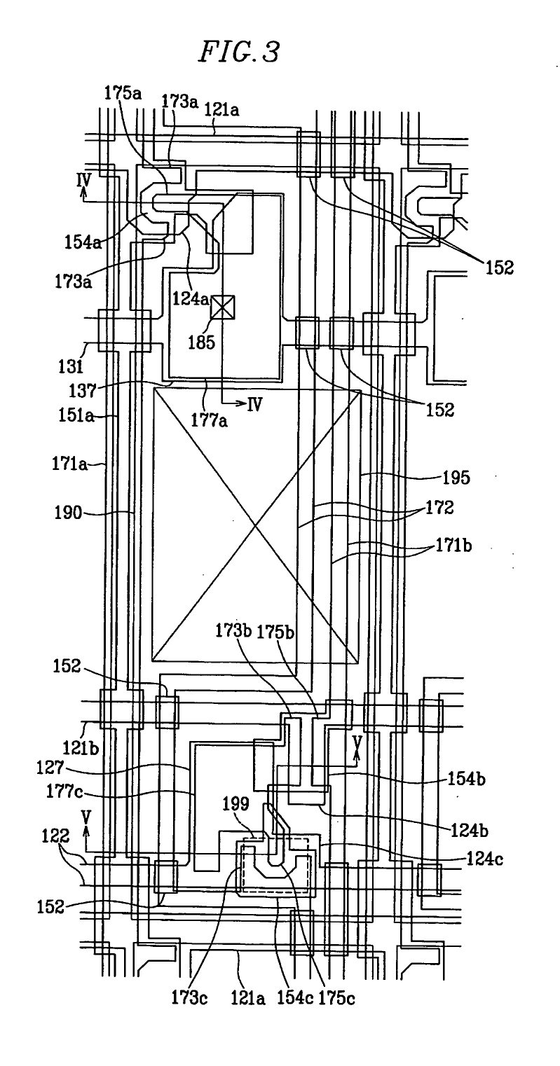

Referring to FIGS. 2 and 3, each pixel PX, for example, a pixel PX1 in the i-th row (i=1, 2, . . . , n) and the j-th column (j=1, 2, . . . , m) includes a display circuit DC connected to display signal lines Gᵢ and Dⱼ and a photo sensing circuit SC connected to sensor signal lines Sᵢ, Pⱼ, Psg, and Psd. However, only a given number of the pixels PX may include the sensing circuits SC, that is, not all pixels PX need include the sensing circuit SC. In other words, the concentration of the sensing circuits SC may be varied and thus the number N of the sensor scanning lines S₁-S_{N} and the number M of the sensor data lines P₁-P_{M} may be varied. Thus, there need not be a one to one correspondence between the display circuits DC and the sensing circuits SC.

In other alternative embodiments, the sensing circuits SC may be separated from the pixels PX and may be provided between the pixels PX or in a separately prepared area.

The display circuit DC includes a switching element Qs1 connected to an image scanning line Gᵢ (i.e., a gate line) and an image data line Dⱼ, and a LC capacitor Clc and a storage capacitor Cst that are connected to the switching element Qs1. In an alternative embodiment, the storage capacitor Cst may be omitted.

The switching element Qs1, such as a TFT, is provided on the lower panel of the LC panel assembly and has three terminals, i.e., a control terminal connected to the image scanning line Gᵢ, an input terminal connected to the image data line Dⱼ, and an output terminal connected to the LC capacitor Clc and the storage capacitor Cst.

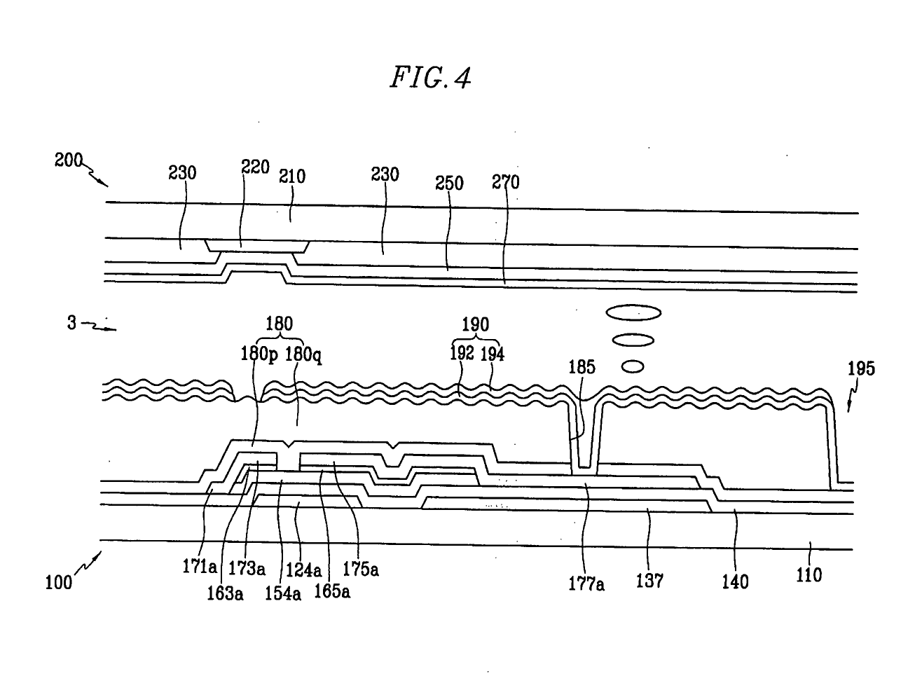

The LC capacitor Clc includes a pair of terminals and an LC layer 3 (as shown in FIG. 4) interposed therebetween and it is connected between the switching element Qs1 and a common voltage Vcom. The two terminals of the LC capacitor Clc may be disposed on two panels 100, 200 of the LC panel assembly 300. One of the two terminals is often referred to as a pixel electrode formed on a TFT array panel 100 having the display signal lines and the sensor signal lines, and the other of the two terminals is often referred to as a common electrode, formed on a common electrode panel 200. The common electrode covers an entire area, or at least substantially an entire area, of the common electrode panel 200 and is supplied with a common voltage Vcom.

The storage capacitor Cst is an auxiliary capacitor for the LC capacitor Clc. The storage capacitor Cst assists the LC capacitor Clc and is connected between the switching element Qs1 and a predetermined voltage such as the common voltage Vcom. The storage capacitor Cst may include the pixel electrode on the TFT array panel 100 and a separate signal line, which is provided on one of the two panels and overlaps the pixel electrode via an insulator. Alternatively, the storage capacitor Cst includes the pixel electrode and an adjacent image scanning line called a previous image scanning line, which overlaps the pixel electrode via an insulator.

For a color display, each pixel PX uniquely represents one of three colors, such as primary colors, (i.e., spatial division) or each pixel PX sequentially represents the colors in turn (i.e., temporal division) such that a spatial or temporal sum of the colors is recognized as a desired color. An example of a set of the three colors includes red, green, and blue colors. In an example of the spatial division, each pixel PX includes a color filter representing one of the primary colors in an area facing the pixel electrode 190, such as in an area of the common electrode panel 200 facing an associated pixel electrode on the TFT array panel 100. Alternatively, the color filter may be provided on or under the pixel electrode of the TFT array panel 100.

The photo sensing circuit SC shown in FIG. 2 includes a photo sensing element Qp connected to a control voltage line Psg and an input voltage line Psd, a sensor capacitor Cp connected to the photo sensing element Qp, and a switching element Qs2 connected to a sensor scanning line Sᵢ, the photo sensing element Qp, and a sensor data line Pⱼ.

The photo sensing element Qp has three terminals, i.e., a control terminal connected to the control voltage line Psg to be biased by the sensor control voltage, an input terminal connected to the input voltage line Psd to be biased by the sensor input voltage, and an output terminal connected to the switching element Qs2. The photo sensing element Qp includes a photoelectric material that generates a photocurrent upon receipt of light. An example of the photo sensing element Qp is a TFT having an amorphous silicon a-Si or polysilicon polySi channel that can generate a photocurrent. The sensor control voltage applied to the control terminal of the photo sensing element Qp by the control voltage line Psg is sufficiently low or sufficiently high to maintain the photo sensing element Qp in an off state without incident light. The sensor input voltage applied to the input terminal of the photo sensing element Qp by the input voltage line Psd is sufficiently high or sufficiently low to keep the photocurrent flowing in a direction. The photocurrent flows toward the switching element Qs2 by the sensor input voltage and it also flows into the sensor capacitor Cp to charge the sensor capacitor Cp.

The sensor capacitor Cp is connected between the control terminal and the output terminal of the photo sensing element Qp. The sensor capacitor Cp stores electrical charges output from the photo sensing element Qp to maintain a predetermined voltage. In an alternative embodiment, the sensor capacitor Cp may be omitted.

The switching element Qs2 also has three terminals, i.e., a control terminal connected to the sensor scanning line Sᵢ, an input terminal connected to the output terminal of the photo sensing element Qp, and an output terminal connected to the sensor data line Pⱼ. The switching element Qs2 outputs a sensor output signal to the sensor data line Pⱼ in response to the sensor scanning signal from the sensor scanning line Sᵢ. That is, when the sensor scanning signal causes the switching element Qs2 to be in an on state via the control terminal of the switching element Qs2, then the switching element Qs2 outputs the sensor output signal to the sensor data line Pⱼ. The sensor output signal is a sensing current from the photo sensing element Qp. However, the sensor output signal may be a voltage stored in the sensor capacitor Cp.

The switching elements Qs1 and Qs2 and the photo sensing element Qp may include amorphous silicon a-Si or polysilicon polySi TFTs.

One or more polarizers (not shown) are provided at the LC panel assembly 300. For example, a first polarized film and a second polarized film may be disposed on the TFT array panel 100 and the common electrode panel 200, respectively. The first and second polarized films adjust a transmission direction of light externally provided into the TFT array panel 100 and the common electrode panel 200, respectively, in accordance with an aligned direction of the liquid crystal layer. The first and second polarized films may have first and second polarized axes thereof substantially perpendicular to each other.

With reference again to FIG. 1, the gray voltage generator 550 generates a plurality of gray scale voltages relating to the brightness of the LCD. The gray voltage generator 550 generates two sets of a plurality of gray voltages related to a transmittance of the pixels, and provides the gray voltages to the image data driver 500. The image data driver 500 applies the gray voltages, which are selected for each data line D₁-Dₘ, by control of the signal controller 600, to the data line respectively as a data signal. The gray voltages in a first set have a positive polarity with respect to the common voltage Vcom, while the gray voltages in a second set have a negative polarity with respect to the common voltage Vcom.

The image scanning driver 400 is connected to the image scanning lines G₁-Gₙ of the LC panel assembly 300 and synthesizes a gate-on voltage and a gate-off voltage input from an external device to generate the image scanning signals for application to the image scanning lines G₁-Gₙ. The image scanning driver 400 may include a plurality of integrated circuits (“ICs”).

The image data driver 500 is connected to the image data lines D₁-Dₘ of the LC panel assembly 300 and applies image data signals selected from the gray voltages supplied from the gray voltage generator 550 to the image data lines D₁-Dₘ, and may also include a plurality of ICs.

The sensor scanning driver 700 is connected to the sensor scanning lines S₁-S_{N} of the LC panel assembly 300 and synthesizes a gate-on voltage and a gate-off voltage to generate the sensor scanning signals for application to the sensor scanning lines S₁-S_{N}.

The sensing signal processor 800 is connected to the sensor data lines P₁-P_{M} of the LC panel assembly 300 and receives and processes the sensor data signals from the sensor data lines P₁-P_{M}. One sensor data signal carried by one sensor data line P₁-P_{M} at a time may include one sensor output signal from one switching element Qs2 or may include at least two sensor output signals outputted from at least two switching elements Qs2.

The signal controller 600 controls the image scanning driver 400, the image data driver 500, the sensor scanning driver 700, and the sensing signal processor 800, etc.

Each of the processing units 400, 500, 600, 700 and 800 may include at least one IC chip mounted on the LC panel assembly 300, such as in a “chip on glass” (“COG”) type of mounting, or on a flexible printed circuit (“FPC”) film in a tape carrier package (“TCP”) type, which are attached to the LC panel assembly 300. Alternately, at least one of the processing units 400, 500, 600, 700, and 800 may be integrated into the LC panel assembly 300 along with the signal lines G₁-Gₙ, D₁-Dₘ, S₁-S_{N}, P₁-P_{M,} Psg, and Psd, the switching elements Qs1 and Qs2, and the photo sensing elements Qp. Alternatively, all the processing units 400, 500, 600, 700 and 800 may be integrated into a single IC chip, but at least one of the processing units 400, 500, 600, 700 and 800 or at least one circuit element in at least one of the processing units 400, 500, 600, 700 and 800 may be disposed out of the single IC chip.

Now, the operation of the above-described LCD will be further described.

The signal controller 600 is supplied with input image signals R, G, and B and input control signals for controlling the display thereof from an external graphics controller (not shown). The input control signals include a vertical synchronization signal Vsync, a horizontal synchronization signal Hsync, a main clock MCLK, and a data enable signal DE.

On the basis of the input control signals and the input image signals R, G and B, the signal controller 600 generates image scanning control signals CONT1, image data control signals CONT2, sensor scanning control signals CONT3, and sensor data control signals CONT4, and processes the image signals R, G and B suitable for the operation of the LC panel assembly 300. The signal controller 600 then provides the scanning control signals CONT1 to the image scanning driver 400, the processed image signals DAT and the data control signals CONT2 to the image data driver 500, the sensor scanning control signals CONT3 to the sensor scanning driver 700, and the sensor data control signals CONT4 to the sensing signal processor 800.

The image scanning control signals CONT1 include an image scanning start signal STV for informing the beginning of a frame and having instructions to start image scanning and at least one clock signal for controlling the output time of the gate-on voltage. The image scanning control signals CONT1 may further include an output enable signal OE for defining the duration of the gate-on voltage.

The image data control signals CONT2 include a horizontal synchronization start signal STH for informing the image data driver 500 of the start of image data transmission for a group of pixels PX, a load signal LOAD having instructions to apply the image data signals to the image data lines D₁-Dₘ, and a data clock signal HCLK. The image data control signals CONT2 may further include an inversion signal RVS for reversing the polarity of the image data signals (with respect to the common voltage Vcom).

Responsive to the image data control signals CONT2 from the signal controller 600, the image data driver 500 receives a packet of the digital image signals DAT, the processed image signals, for the group of pixels PX from the signal controller 600, converts the digital image signals DAT into analog image data signals selected from the gray voltages supplied from the gray voltage generator 550, and applies the analog image data signals to the image data lines D₁-Dₘ.

The image scanning driver 400 applies the gate-on voltage to an image scanning line G₁-Gₙ in response to the image scanning control signals CONT1 from the signal controller 600, thereby turning on the switching elements Qs1 connected thereto. The image data signals applied to the image data lines D₁-Dₘ are then supplied to the display circuit DC of the pixels PX through the activated switching elements Qs1.

The difference between the voltage of an image data signal applied to the pixel and the common voltage Vcom is represented as a voltage across the LC capacitor Clc, which is referred to as a pixel voltage. The LC molecules in the LC capacitor Clc have orientations depending on the magnitude of the pixel voltage, and the molecular orientations determine the polarization of light passing through the LC layer 3. The polarizer(s) converts the light polarization into the light transmittance to display images.

By repeating this procedure by a unit of a horizontal period (also referred to as “1H” and equal to one period of the horizontal synchronization signal Hsync and the data enable signal DE), all image scanning lines G₁-Gₙ are sequentially supplied with the gate-on voltage, thereby applying the image data signals to all pixels PX to display an image for a frame.

When the next frame starts after one frame finishes, the inversion control signal RVS, part of the image data control signals CONT2, applied to the image data driver 500 is controlled such that the polarity of the image data signals is reversed (which is referred to as “frame inversion”). The inversion control signal RVS may also be controlled such that the polarity of the image data signals flowing in a data line are periodically reversed during one frame (for example, row inversion and dot inversion), or the polarity of the image data signals in one packet are reversed (for example, column inversion and dot inversion).

In the meantime, the sensor scanning driver 700 applies the gate-on voltage to the sensor scanning lines S₁-S_{N} to turn on the switching elements Qs2 connected thereto via the control terminals of the switching elements Qs2 in response to the sensing control signals CONT3. Then, the switching elements Qs2 output sensor output signals to the sensor data lines P₁-P_{M} via the output terminals of the switching elements Qs2 to form sensor data signals, and the sensor data signals are inputted into the sensing signal processor 800 via the sensor data lines P₁-P_{M}.

The sensing signal processor 800 reads sensor data signals from the sensor data lines P₁-P_{M} in response to the sensor data control signals CONT4 and the sensing signal processor 800 processes, for example, amplifies and filters the read sensor data signals from the sensor data lines P₁-P_{M}. The sensing signal processor 800 converts the analog sensor data signals into touch information signals DSN and outputs the touch information signals DSN to an external device. The external device appropriately processes the touch information signals DSN to determine whether and where a touch exists and sends image signals generated based on information about the touch to the LCD.

Now, structures of exemplary embodiments of LC panel assemblies according to the present invention will be described in further detail with reference to FIGS. 3, 4, and 5.

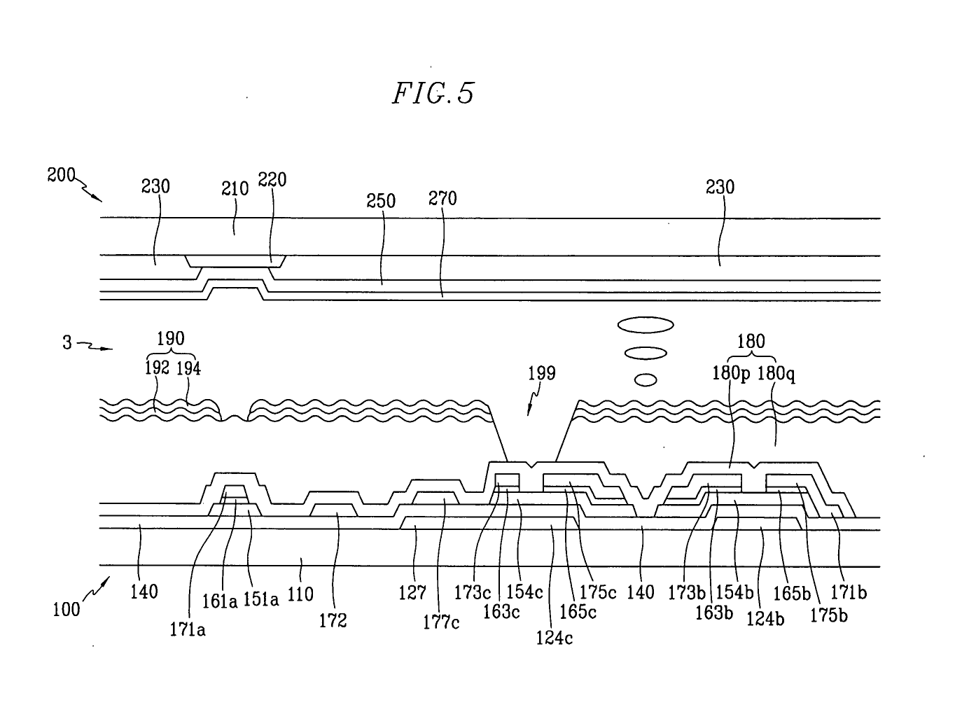

FIG. 3 is a layout view of an exemplary embodiment of an LC panel assembly according to the present invention, FIG. 4 is a sectional view of the LC panel assembly shown in FIG. 3 taken along line IV-IV, and FIG. 5 is a sectional view of the LC panel assembly shown in FIG. 3 taken along line V-V.

Each of the LC panel assemblies includes a TFT array panel 100, a common electrode panel 200 facing the TFT array panel 100, and an LC layer 3 interposed between the panels 100 and 200.

The TFT array panel 100 will now be described in further detail.

A plurality of gate conductors including a plurality of image scanning lines 121a, a plurality of storage electrode lines 131, a plurality of sensor scanning lines 121b, and a plurality of control voltage lines 122 are formed on an insulating substrate 110 such as, but not limited to, transparent glass or plastic.

The image scanning lines 121a are separated from each other, transmit image scanning signals, and extend substantially in a transverse direction. The image scanning lines 121a may extend substantially parallel to each other. The image scanning lines 121a may extend to be connected to a driving circuit of the image scanning driver 400. Each of the image scanning lines 121a includes a plurality of first control electrodes 124a projecting downward. For example, the first control electrodes 124a may project in a direction perpendicular to the transverse direction that the image scanning lines 121a extend.

The storage electrode lines 131 are supplied with a predetermined voltage such as a common voltage and extend substantially parallel to the image scanning lines 121a. Each of the storage electrode lines 131 is disposed close to an image scanning line 121a and includes a plurality of storage electrodes 137 expanding upward and downward. That is, the storage electrodes 137, while lying in substantially the same layer as the storage electrode lines 131, may project in a direction perpendicular to the transverse direction that the storage electrode lines 131 extend.

The sensor scanning lines 121b transmit sensor scanning signals and extend substantially parallel to the image scanning lines 121a. Each of the sensor scanning lines 121b includes a plurality of second control electrodes 124b projecting downward. That is, the second control electrodes 124b, while lying in substantially the same layer as the sensor scanning lines 121b, may project in a direction perpendicular to the direction that the sensor scanning lines 121b extend.

The control voltage lines 122 are supplied with a sensor control voltage and extend substantially parallel to the sensor scanning lines 121b. Each of the control voltage lines 122 is disposed close to a sensor scanning line 121b and includes a plurality of third control electrodes 124c projecting upward and a plurality of expansions 127 also projecting upward. That is, the third control electrodes 124c and the expansions 127, while lying in substantially the same layer as the control voltage lines 122, project in directions away from the direction that the control voltage lines 122 extend.

The gate conductors 121a, 121b, 122 and 131 are preferably made of aluminum Al containing metal such as Al and Al alloy, silver Ag containing metal such as Ag and Ag alloy, copper Cu containing metal such as Cu and Cu alloy, molybdenum Mo containing metal such as Mo and Mo alloy, chromium Cr, tantalum Ta, or titanium Ti. However, they may have a multi-layered structure including two conductive films (not shown) having different physical characteristics. If a multi-layered structure is employed, one of the films is preferably made of low resistivity metal including Al containing metal, Ag containing metal, and Cu containing metal for reducing signal delay or voltage drop, and another film is preferably made of material such as Mo containing metal, Cr, Ta, or Ti, which has good physical, chemical, and electrical contact characteristics with other materials such as indium tin oxide (“ITO”) or indium zinc oxide (“IZO”). Examples of the combination of two films that provide an appropriate combination of preferable characteristics include a lower Cr film and an upper Al (alloy) film and a lower Al (alloy) film and an upper Mo (alloy) film. However, the gate conductors 121a, 121b, 122 and 131 may be made of various metals or conductors.

The lateral sides of the gate conductors 121a, 121b, 122 and 131 are inclined relative to a surface of the insulating substrate 110, and the inclination angle thereof is within a range of about 30 to about 80 degrees.

A gate insulating layer 140, preferably made of silicon nitride (SiNx) or silicon oxide (SiOx), is formed on the gate conductors 121a, 121b, 122 and 131. The gate insulating layer 140 may further be formed on portions of the insulating substrate 110 that is not covered by the gate conductors 121a, 121b, 122, and 131.

A plurality of semiconductor stripes 151a and a plurality of semiconductor islands 154b, 154c, and 152 are formed on the gate insulating layer 140. The semiconductor stripes and islands 151a, 154b, 154c and 152 are preferably made of hydrogenated amorphous silicon (abbreviated to “a-Si”) or polysilicon.

The semiconductor stripes 151a extend substantially in a longitudinal direction, generally perpendicular to the transverse direction of the gate conductors 121a, 121b, 122, and 131. The semiconductor stripes 151a become wide near the scanning lines 121a and 121b, the storage electrode lines 131, and the control voltage lines 122 such that the semiconductor stripes 151a cover large areas of the scanning lines 121a and 121b, the storage electrode lines 131, and the control voltage lines 122. Each of the semiconductor stripes 151a has a plurality of projections 154a disposed on the first control electrodes 124a.

The semiconductor islands 154b and 154c are disposed on the second and third control electrodes 124b and 124c, respectively, and each of the semiconductor islands 154b includes an extension covering edges of the sensor scanning lines 121b.

The semiconductor islands 152 are disposed on the scanning lines 121a and 121b, the storage electrode lines 131, and the control voltage lines 122.

A plurality of ohmic contact stripes 161a and a plurality of first ohmic contact islands 165a are formed on the semiconductor stripes 151a, a plurality of second and third ohmic contact islands 163b and 165b are formed on the semiconductor islands 154b, and a plurality of fourth and fifth ohmic contact islands 163c and 165c are formed on the semiconductor islands 154c. In addition, a plurality of other ohmic contact islands (not shown) are formed on the semiconductor islands 152. The ohmic contact stripes and islands 161a, 163b, 163c and 165a-165c are preferably made of silicide or n+ hydrogenated a-Si heavily doped with n type impurity such as phosphorous. It should be understood that an impurity is a substance that is incorporated into a semiconductor material and provides free electrons (n-type impurity) or holes (p-type impurity).

Each of the ohmic contact stripes 161a includes a plurality of projections 163a, and the projections 163a and the first ohmic contact islands 165a are located in pairs on the projections 154a of the semiconductor stripes 151a. The second and the third ohmic contact islands 163b and 165b are located in pairs on the semiconductor islands 154b, and the fourth and fifth ohmic contact islands 163c and 165c are located in pairs on the semiconductor islands 154c.

The lateral sides of the semiconductor stripes and islands 151a, 154b, 154c and 152 and the ohmic contact stripes and islands 161a, 163b, 163c and 165a-165c are inclined relative to the surface of the insulating substrate 110, and the inclination angles thereof are preferably in a range of about 30 to about 80 degrees.

A plurality of data conductors including a plurality of image data lines 171a, a plurality of sensor data lines 171b, a plurality of electrode members 177c, a plurality of input voltage lines 172, and a plurality of first output electrodes 175a are formed on the ohmic contact stripes and islands 161a, 163b, 163c and 165a-165c and the gate insulating layer 140.

The image data lines 171a transmit image data signals and extend substantially in the longitudinal direction, substantially perpendicular to the image scanning lines 121a and sensor scanning lines 121b, to intersect the scanning lines 121a and 121b, the storage electrode lines 131, and the control voltage lines 122. Each of the image data lines 171a includes a plurality of first input electrodes 173a projecting toward the first control electrodes 124a.

The first output electrodes 175a are separated from the image and sensor data lines 171a and 171b and the input voltage lines 172, and the first output electrodes 175a are disposed opposite the first input electrodes 173a with respect to the first control electrodes 124a. Each of the first output electrodes 175a includes a wide end portion 177a and a narrow end portion. The wide end portion 177a overlaps a storage electrode 137 and the narrow end portion is partly surrounded by a first input electrode 173a that is curved.

The sensor data lines 171b transmit sensor data signals and extend substantially in the longitudinal direction, parallel to the image data lines 171a, to intersect the scanning lines 121a and 121b, the storage electrode lines 131, and the control voltage lines 122. Each of the sensor data lines 171b includes a plurality of second output electrodes 175b projecting toward the second control electrodes 124b.

The electrode members 177c are separated from the data lines 171a and 171b and the input voltage lines 172. Each of the electrode members 177c overlaps an expansion 127 of a control voltage line 122 to form a sensor capacitor Cp and includes a second input electrode 173b and a third output electrode 175c disposed on the ohmic contacts 163b and 165c, respectively. The second input electrode 173b faces a second output electrode 175b and is separated from the second output electrode 175b.

The input voltage lines 172 transmit a sensor input voltage and extend substantially in the longitudinal direction, substantially parallel to the image data lines 171a and the sensor data lines 171b, to intersect the scanning lines 121a and 121b, the storage electrode lines 131, and the control voltage lines 122. Each of the input voltage lines 172 curves around the electrode members 177c and includes a plurality of third input electrodes 173c projecting toward the third control electrodes 124c. The third input electrodes 173c are disposed opposite the third output electrodes 175c with respect to the third control electrodes 124c and they are curved to have a U-shape to partly surround the third output electrodes 175c.

A first control electrode 124a, a first input electrode 173a, and a first output electrode 175a along with a projection 154a of a semiconductor stripe 151a form a switching TFT, switching element Qs1, having a channel formed in the projection 154a disposed between the first input electrode 173a and the first output electrode 175a.

A second control electrode 124b, a second input electrode 173b, and a second output electrode 175b along with a semiconductor island 154b form a switching TFT, switching element Qs2, having a channel formed in the semiconductor island 154b disposed between the second input electrode 173b and the second output electrode 175b.

A third control electrode 124c, a third input electrode 173c, and a third output electrode 175c along with a semiconductor island 154c form a photosensor TFT, photo sensing element Qp, having a channel formed in the semiconductor island 154c disposed between the third input electrode 173c and the third output electrode 175c. In an alternative embodiment, the photo sensing element Qp may be substituted with a pressure sensor TFT Qt.

The data conductors 171a, 171b, 172, 175a, and 177c are preferably made of refractory metal such as Cr, Mo, Ta, Ti, or alloys thereof. However, they may have a multilayered structure including a refractory metal film (not shown) and a low resistivity film (not shown). Examples of the multi-layered structure having a good combination of properties include, but are not limited to, a double-layered structure including a lower Cr/Mo (alloy) film and an upper Al (alloy) film and a triple-layered structure of a lower Mo (alloy) film, an intermediate Al (alloy) film, and an upper Mo (alloy) film. However, the data conductors 171a, 171b, 172, 175a, and 177c may be made of various metals or conductors.

The data conductors 171a, 171b, 172, 175a, and 177c have tapered lateral sides with inclined edge profiles, and the inclination angles thereof range about 30 to about 80 degrees with respect to the insulating substrate 110.

The ohmic contact stripes and islands 161a, 163b, 163c and 165a-165c are interposed only between the underlying semiconductor stripes and islands 151a, 154b, 154c and 152 and the overlying data conductors 171a, 171b, 172, 175a and 177c thereon and reduce the contact resistance therebetween.

Although the semiconductor stripes 151a are narrower than the image data lines 171a at most places, the width of the semiconductor stripes 151a becomes large near the scanning lines 121a and 121b, the storage electrode lines 131, and the control voltage lines 122 as described above, to smooth the profile of the surface, thereby preventing the disconnection of the image data lines 171a and the input voltage lines 172. Likewise, the semiconductor islands 152 and the extensions of the semiconductor islands 154b disposed on the edges of the scanning lines 121a and 121b, the storage electrode lines 131, and the control voltage lines 122 smooth the profile of the surface to prevent the disconnection of the sensor data lines 171b and the input voltage lines 172 thereon. The semiconductor stripes and islands 151a, 154b, 154c and 152 include some exposed portions, which are not covered with the data conductors 171a, 171b, 172, 175a and 177c, such as portions located between the input electrodes 173a-173c and the output electrodes 175a-175c.

A passivation layer 180 is formed on the data conductors 171a, 171b, 172, 175a, and 177c, and the exposed portions of the semiconductor stripes and islands 151a, 154b, 154c and 152. The passivation layer 180 may also be formed on any other exposed portions of the gate insulating layer 140.

The passivation layer 180 includes a lower passivation film 180p preferably made of inorganic insulator such as silicon nitride or silicon oxide and an upper passivation film 180q preferably made of organic insulator. The organic insulator of the upper passivation film 180q preferably has dielectric constant less than about 4.0 and it may have photosensitivity. The upper passivation film 180q has a plurality of openings exposing portions of the lower passivation film 180p and it has unevenness on its surface, and is therefore not planar. In an alternative embodiment, the passivation layer 180 may have a single-layer structure preferably made of inorganic or organic insulator.

The passivation layer 180 has a plurality of contact holes 185 exposing the wide end portions 177a of the first output electrodes 175a. The contact holes 185 may have inclined or stepped sidewalls.

A plurality of pixel electrodes 190 are formed on the passivation layer 180.

Each of the pixel electrodes 190 has unevenness following the unevenness of the upper passivation film 180q and includes a transparent electrode 192 and a reflective electrode 194 disposed thereon. The transparent electrode 192 is preferably made of transparent conductor such as ITO or IZO, and the reflective electrode 194 is preferably made of Al, Ag, Cr, or alloys thereof. However, the reflective electrode 194 may have a dual-layered structure including a low-resistivity, reflective upper film (not shown) preferably made of Al, Ag, or alloys thereof and a good contact lower film (not shown) preferably made of Mo containing metal, Cr, Ta, or Ti having good contact characteristics with ITO or IZO.

The reflective electrode 194 has a transmissive window 195 disposed in an opening of the upper passivation film 180q and exposing the transparent electrode 192. In addition, the reflective electrode 194 has an opening 199 disposed on the photo sensing element Qp.

The pixel electrodes 190 are physically and electrically connected to the first output electrodes 175a through the contact holes 185, such as via the wide end portions 177a, such that the pixel electrodes 190 receive data voltages from the first output electrodes 175a. The pixel electrodes 190 supplied with the image data voltages generate electric fields in cooperation with a common electrode 270 of the common electrode panel 200 supplied with a common voltage Vcom, which determine the orientations of liquid crystal molecules of the liquid crystal layer 3 disposed between the two electrodes 190 and 270. The pixel electrode 190 and the common electrode 270 form an LC capacitor Clc, which stores applied voltages after the switching element Qs1 turns off.

A pixel of the LC panel assembly 300 including the TFT array panel 100, the common electrode panel 200, the LC layer 3, etc., can be divided into a transmissive region TA and a reflective region RA defined by the transparent electrode 192 and the reflective electrode 194, respectively. In particular, the transmissive region TA includes portions disposed on and under the transmissive windows 195, while the reflective region RA includes portions disposed on and under the reflective electrodes 194. In the transmissive region TA, light incident from a rear surface of the LC panel assembly 300, i.e., light that passes from the TFT array panel 100, and through the LC layer 3, and out of a front surface, i.e., out of the common electrode panel 200, thereby displays images. In the reflective regions RA, light incident from the front surface enters into the LC layer 3, is reflected by the reflective electrode 194, passes through the LC layer 3 again, and goes out of the front surface, thereby displaying images. At this time, the unevenness of the reflective electrode 194 enhances the efficiency of the light reflection.

A pixel electrode 190 and a wide end portion 177a of a first output electrode 175a connected thereto overlap a storage electrode line 131 including a storage electrode 137 to form a storage capacitor Cst, which enhances the voltage storing capacity of the liquid crystal capacitor Clc.

The pixel electrodes 190 overlap the scanning lines 121a and 121b, the data lines 171a and 171b, the control voltage lines 122, the input voltage lines 172, and the TFTs including the switching elements Qs1 and Qs2 and the photo sensing element Qp to increase the aperture ratio.

A description of the common electrode panel 200 will follow.

A light blocking member 220, referred to as a black matrix for preventing light leakage, is formed on an insulating substrate 210 such as, but not limited to, transparent glass or plastic. The light blocking member 220 defines a plurality of open areas facing the pixel electrodes 190.

A plurality of color filters 230 are also formed on the insulating substrate 210 and they are disposed substantially in the open areas enclosed by the light blocking member 220. The color filters 230 may extend substantially along the longitudinal direction along the pixel electrodes 190 to form stripes. Each of the color filters 230 may represent one of three colors or the primary colors such as red, green and blue colors.

An overcoat 250 is formed on the color filters 230 and the light blocking member 220. The overcoat 250 is preferably made of an insulator, such as an organic insulator, and it protects the color filters 230, prevents the color filters 230 from being exposed, and provides a flat surface.

A common electrode 270 is formed on the overcoat 250. The common electrode 270 is preferably made of transparent conductive material such as ITO and IZO, and may cover substantially an entire surface of the common electrode panel 200.

Alignment layers (not shown) for aligning the LC layer 3 may be coated on inner surfaces of the panels 100 and 200, and one or more polarizers (not shown) are provided on outer surfaces of the panels 100 and 200, as previously described.

The LC layer 3 may be subjected to a homeotropic alignment or a homogeneous alignment. The thickness of the LC layer 3 in the transmissive regions TA is thicker than, in particular, about twice a thickness of the LC layer 3 in the reflective regions RA since there is no upper passivation film 180q in the transmissive regions TA.

The LC panel assembly 300 may further include a plurality of elastic spacers (not shown) for forming a gap between the TFT array panel 100 and the common electrode pane 1200.

The LC panel assembly 300 may further include a sealant (not shown) for combining the TFT array panel 100 and the common electrode panel 200. The sealant is disposed around edges of the common electrode panel 200.

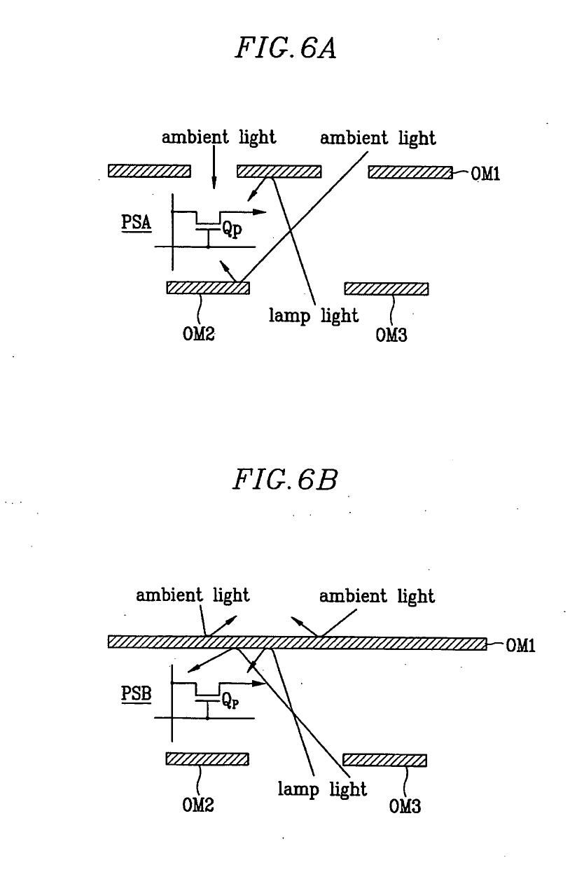

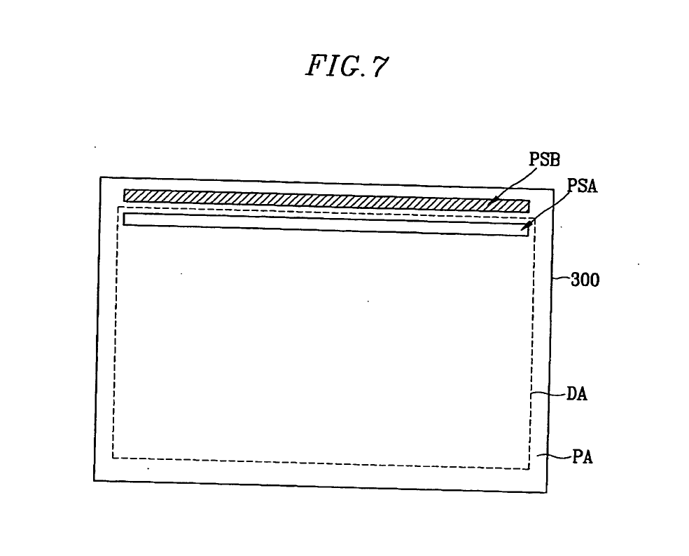

In the meantime, an exemplary embodiment of an LCD according to the present invention further includes at least one reference photo sensing circuit as well as the above-described photo sensing circuits (referred to as “touch sensing circuits” hereinafter), for sensing front light, ambient light, or rear light emitted from a lamp of a lighting unit (not shown), where the sensing circuits will be described with reference to FIGS. 6A, 6B, and 7 as well as FIGS. 1-5.

FIGS. 6A and 6B are schematic diagrams of exemplary embodiments of reference photo sensing circuits according to the present invention, and FIG. 7 is a schematic diagram of an exemplary LC panel assembly including the exemplary reference photo sensing circuits shown in FIGS. 6A and 6B.

Referring to FIG. 7, an LC panel assembly 300 includes a display area DA displaying images and a peripheral area PA surrounding the display area DA. Most of the pixels PX are provided in the display area DA.

A first reference sensing circuit PSA shown in FIG. 6A includes a photo sensing element Qp, a switching element (e.g. Qs2 as shown in FIG. 2), and a sensing capacitor (e.g. Cp as shown in FIG. 2). The first reference sensing circuit PSA may be one of the above-described photo sensing circuits SC shown in FIG. 2, which is connected to one of the sensor scanning lines S₁-S_{M} shown in FIG. 1. The first reference sensing circuit PSA is provided in the display area DA and disposed adjacent to the peripheral area PA. However, the first reference sensing circuit PSA may instead be provided in the peripheral area PA. The position of the first reference sensing circuit PSA is predetermined so that a touch followed by a shadow may not disturb the first reference sensing circuit PSA.

A second reference sensing circuit PSB shown in FIG. 6B also includes a photo sensing element Qp, a switching element such as another TFT(not shown), and a sensing capacitor (not shown), and the second reference sensing circuit PSB is provided in the peripheral area PA. The second reference sensing circuit PSB is disposed near an upper edge of the LC panel assembly 300 and adjacent to the first reference sensing circuit PSA. The second reference sensing circuit PSB may be connected to a separate sensor scanning line (not shown), such as a second reference scanning line, that is provided independent from the sensor scanning lines S₁-S_{N} shown in FIG. 1.

The positions of the reference sensing units PSA and PSB may be varied and should not be limited by the illustrated embodiments. By example only, the reference sensing units PSA and PSB may alternatively be disposed near a lower edge of the LC panel assembly 300.

Referring to FIG. 6A, the first reference sensing circuit PSA, and in particular, a channel of the photo sensing element Qp of the first reference sensing circuit PSA directly receives ambient, front light since there is no upper opaque member OM1 on the photo sensing element Qp of the first reference sensing circuit PSA. The first reference sensing circuit PSA may also indirectly receive the ambient light after guided by opaque members OM1, OM2, and OM3, by the first reference sensing circuit PSA itself, or by other elements. Guided light may herein refer to light that reaches the first reference sensing circuit PSA after experiencing at least one reflection.

Referring to FIGS. 3-5, the upper opaque members OM1 may include the light blocking member 220, the reflective electrodes 194, the data conductors 171a, 171b, 172, 175a, and 177c, etc., which are disposed on the semiconductors 151a, 152, 154b, and 154c. The opaque member OM2 disposed just below the photo sensing element Qp may be a control electrode 124c of the photo sensing element Qp. The opaque member OM3, which may be disposed in a same layer as the opaque member OM2, may include the gate conductors 121a, 121b, 122, and 131, etc., which are disposed under the semiconductors 151a, 152, 154b, and 154c.

In addition, the first reference sensing circuit PSA also receives rear light substantially in an indirect manner, for example, by way of reflection, etc. The rear light, indicated as lamp light, is emitted from a lamp (not shown) of a lighting unit such as a backlight assembly (not shown) for illuminating the pixels PX of the LC panel assembly 300.

On the contrary, referring to FIG. 6B, the second reference sensing circuit PSB receives only the light originated from the lamp of the lighting unit of the LCD since the upper opaque member OM1 has no opening for allowing entry of ambient light. That is, the channel of the photo sensing element Qp of the second reference sensing circuit PSB receives the rear light, the lamp light, substantially in an indirect manner, for example, by way of reflection, etc. The lamp light may pass between the opaque members OM2 and OM3, and may then be reflected off a rear surface of the opaque member OM1 to be directed to the photo sensing element Qp.

The first/second reference sensing circuits PSA/PSB generate first/second reference sensor output signals upon receipt of light. The reference sensing circuits PSA and PSB are also connected to the sensor data lines P₁-P_{M} shown in FIG. 1 similar to the touch sensing circuits SC such that the reference sensing circuits PSA and PSB output the reference sensor output signals to the sensor data lines P₁-P_{M} to be received by the sensing signal processor 800, as will be further described below.

A touch sensing circuit SC disposed at a touched position receives only a lamp light since a touch is followed by a shadow that blocks ambient light. Therefore, the touch sensing circuit SC disposed at the touched position is in substantially the same state as the second reference sensing circuit PSB shown in FIG. 6B. Accordingly, it is expected that a sensor output signal for the touched position, as provided to the sensor data line P₁-P_{M} to which the touched touch sensing circuit SC is connected, has substantially the same voltage level as the second reference sensor output signal outputted by the second reference sensing circuit PSB.

On the contrary, the touch sensing circuits SC at other positions, when not touched, receive both ambient light and lamp light such that the touch sensing circuits SC at other positions that are not touched are substantially in the same state as the first reference sensing circuit PSA. Accordingly, it is expected that a sensor output signal for an untouched position, as provided to the sensor data line P₁-P_{M} to which the untouched touch sensing circuit SC is connected, has substantially the same voltage level as the first reference sensor output signal outputted by the first reference sensing circuit PSA.

The LCD may include several first/second reference sensing units or circuits PSA/PSB. In this case, the sensor output signals of the reference sensing units PSA/PSB are averaged to generate a reference signal for processing the sensor output signals from the touch sensing circuits SC for exact touch information.

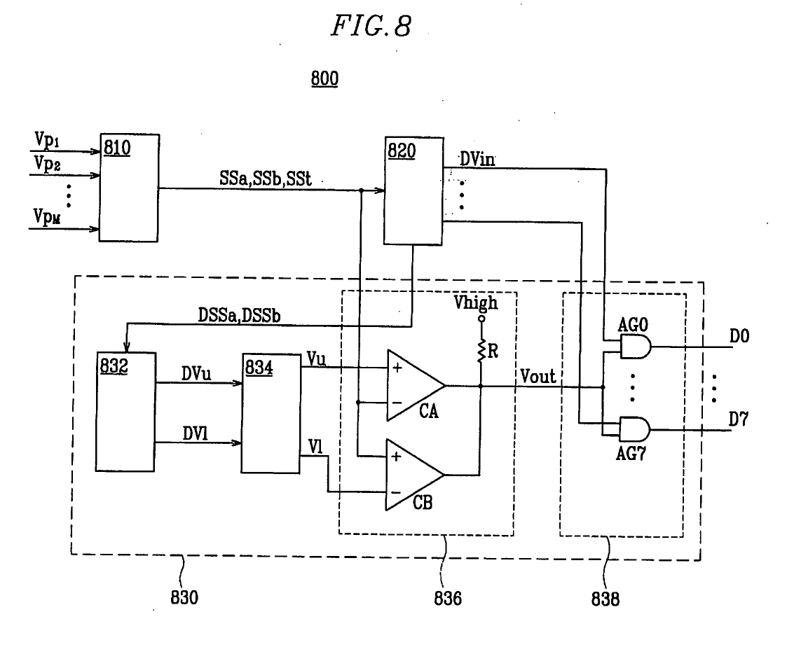

Now, a sensing signal processor of an LCD, which processes sensor output signals from the touch sensing circuits SC based on the reference signal from the reference sensing units PSA and PSB, will be further described with reference to FIGS. 8, 9, and 10.

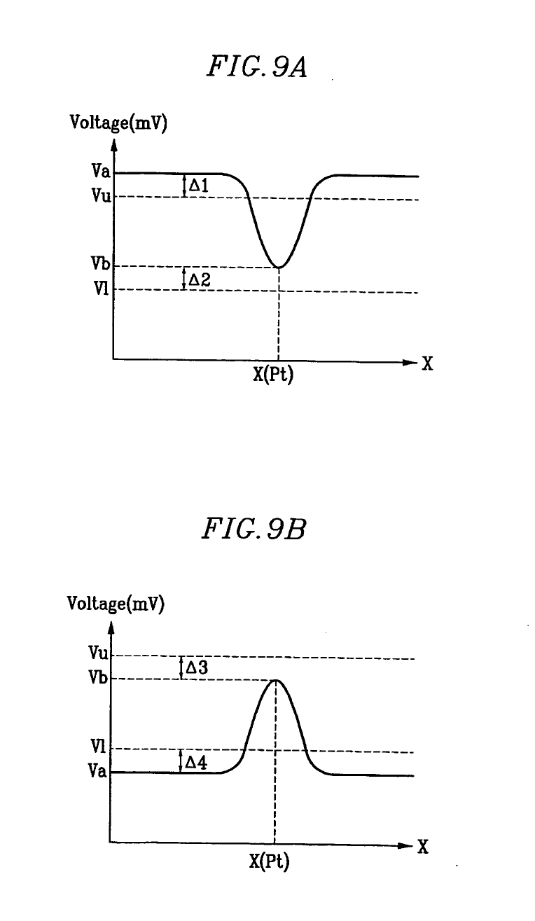

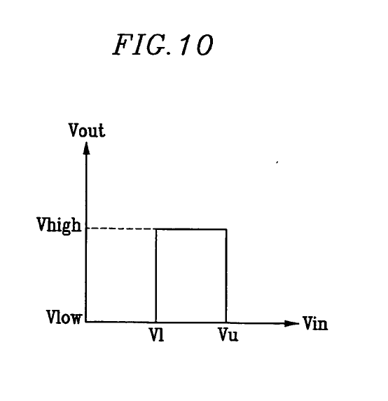

FIG. 8 is a block diagram of an exemplary embodiment of a sensing signal processor for an LCD according to the present invention, FIGS. 9A and 9B are graphs illustrating sensing signals of exemplary embodiments of touch sensing circuits of an LCD according to the present invention, and FIG. 10 is a graph illustrating input-to-output relation of an exemplary comparison unit shown in FIG. 8.

Referring to FIG. 8, a sensing signal processor 800 includes a sensing signal regulator 810, an analog-to-digital converter 820, and a sensing signal extractor 830.

The sensing signal regulator 810 receives a plurality of sets of sensor data signals Vp₁-Vp_{M} from the sensor data lines P₁-P_{M}. Each set of sensor data signals Vp₁-Vp_{M} may be originated from a set of touched and/or untouched touch sensing circuits SC, a set of first reference sensing circuits PSA, or a set of second reference sensing circuits PSB. The sensing signal regulator 810 amplifies and/or filters each set of sensor data signals Vp₁-Vp_{M} and parallel-to-serial converts the set of amplified and/or filtered sensor data signals Vp₁-Vp_{M} into a sequence SSa, SSb, or SSt of serialized sensor data signals, where SSa denotes a signal sequence of serialized sensor data signals for the set of first reference sensing circuits PSA, SSb denotes a signal sequence of serialized sensor data signals for the set of second reference sensing circuits PSB, and SSt denotes a signal sequence of serialized sensor data signals for the set of touch sensing circuits SC.

The analog-to-digital converter (“ADC”) 820 converts each of the sensor data signals in the signal sequences SSa/SSb/SSt of serialized sensor data signals into a digitized sensor data signal. As illustrated in FIG. 8, DSSa denotes a signal sequence of digitized sensor data signals for the set of first reference sensing circuits PSA, DSSb denotes a signal sequence of digitized sensor data signals for the set of second reference sensing circuits PSB, and DVin denotes a signal sequence of digitized sensor data signals for the set of touch sensing circuits SC. The ADC 820 has a predetermined number of output terminals and the predetermined number is equal to the bit number of the signal sequences of the digitized sensor data signals DSSa, DSSb, and DVin.

The sensing signal extractor 830 includes a calculator 832, a digital-to-analog converter 834, a comparison unit 836, and an output unit 838.

The calculator 832 receives the signal sequences of the digitized sensor data signals DSSa/DSSb for the first/second reference sensing circuits PSA/PSB from the analog-to-digital converter 820 and processes the signal sequences of the digitized sensor data signals DSSa/DSSb to generate first/second digital reference signals DVu/DVl. The calculator 832 may include a latch (not shown) storing the signal sequences of the digitized sensor data signals DSSa/DSSb and an operation logic (not shown) generating the first/second digital reference signals DVu/DVl. The processing of the calculator 832 may include averaging of the signal sequences of the digitized sensor data signals DSSa/DSSb and may also include addition of a predetermined value into the averaged digitized sensor data signals.

The digital-to-analog converter (“DAC”) 834 converts the first/second digital reference signals DVl/DVu from the calculator 832 into first/second analog reference signals Vi/Vu.

The comparison unit 836 includes a window comparator, as termed herein, including first and second comparators CA and CB. The first comparator CA has a non-inverting terminal (+) supplied with the second analog reference signal Vu from the DAC 834 and an inverting terminal (−) coupled with the output terminal of the sensing signal regulator 810. The second comparator CB has a non-inverting terminal (+) coupled with the output terminal of the sensing signal regulator 810 and an inverting terminal (−) supplied with the first analog reference signal Vl from the DAC 834. The first and the second comparators CA and CB have a common output connected to a high voltage Vhigh through a resistor R.

Each of the first and the second comparators CA and CB has an output that has a high level when the non-inverting input is higher than the inverting input, and has a low level when the non-inverting input is lower than the inverting input.

Therefore, referring to FIG. 10, when the output of the sensing signal regulator 810 has a value between the first analog reference signal VI and the second analog reference signal Vu, both the first and the second comparators CA and CB have high outputs and thus the output voltage Vout of the comparison unit 836 is high. When the output of the sensing signal regulator 810 is higher than the second analog reference signal Vu, the first comparator CA has a low output. Also, when the output of the sensing signal regulator 810 is lower than the first analog reference signal Vl, the second comparator CB has a low output. The latter two cases yield the output voltage Vout of the comparison unit 836 to be low. In other words, when the output of the sensing signal regulator 810 is lower than the first analog reference signal V1 or higher than the second analog reference signal Vu, then the output voltage Vout of the comparison unit 836 is low, but when the output of the sensing signal regulator 810 is between the first analog reference signal Vl and the second analog reference signal Vu, then the output voltage Vout of the comparison unit 836 is high.

The output unit 838 includes a plurality of AND gates, and the number of the AND gates may be equal to the bit number of the output of the ADC 820. FIG. 8 shows that the bit number of the output of the ADC 820 is equal to eight and thus the output unit 838 includes eight AND gates AG0-AG7. Each of the AND gates AG0-AG7 has a first input terminal coupled to an output terminal of the ADC 820 and a second input terminal coupled with the output of the comparison unit 836.

The output of the output unit 838 varies depending on the output voltage Vout of the comparison unit 836. When the output voltage Vout is high, the output of the output unit 838 is equal to the output of the ADC 820. When the output voltage Vout is low, the output of the output unit 838 is equal to zero (i.e., “00000000”). In other words, when the output of the sensing signal regulator 810 is not between the first/second analog reference signals V1/Vu, then the output of the output unit 838 is equal to zero, but when the output of the sensing signal regulator 810 is between the first and second analog reference signals Vl and Vu, then the output of the output unit 838 is equal to the output of the ADC 820.

The output of the output unit 838 forms an output of the sensing signal processor 800, i.e., touch information signals DSN that informs of a touch, which will be described further with reference to FIGS. 9A and 9B.

The curves shown in FIGS. 9A and 9B indicate sensor data signals as a function of the position of respective sensor data lines P₁-P_{M}, where position is represented by X(P) on the graphs, and a touched position is shown at X(Pt). The sensor data signals are originated from the touch sensing circuits SC connected to one of the sensor scanning lines S₁-S_{N}, and a touch is exerted at an intersection of the sensor scanning line and a sensor data line Pt.

FIG. 9A shows a curve in a shadow mode where a first reference sensor output voltage Va of a first reference sensing circuit PSA (or the analog value of the average of the digitized sensor data signals in the signal sequence DSSa, which is obtained by the calculator 832) is higher than a second reference sensor output voltage Vb of a second reference sensing circuit PSB (or the analog value of the average of the digitized sensor data signals in the signal sequence DSSb). FIG. 9B shows a curve in a lighting mode where a first reference sensor output voltage Va of a first reference sensing circuit PSA is lower than a second reference sensor output voltage Vb of a second reference sensing circuit PSB.

With reference to FIGS. 6A and 6B, the shadow mode works when ambient light is relatively bright, and in particular, when the ambient light received directly by a photo sensing element Qp is brighter than a lamp light reflected by an opaque member OM1 to the photo sensing element Qp. On the contrary, the lighting mode works when the ambient light is relatively dark, and in particular, the ambient light is darker than the lamp light reflected by the opaque member OM1.

In the shadow mode, the second analog reference signal Vu is determined to be equal to the first reference sensor output voltage Va subtracted by a predetermined value Δ1. Similarly, the first analog reference signal Vl is determined to be equal to the second reference sensor output voltage Vb subtracted by a predetermined value Δ2.

In the lighting mode, the second analog reference signal Vu is determined to be equal to the second reference sensor output voltage Vb added by a predetermined value Δ3. Similarly, the first analog reference signal V1 is determined to be equal to the first reference sensor output voltage Va added by a predetermined value Δ4.

As shown in FIGS. 9A and 9B, the sensor data signals for the touch sensing units SC near the touched position X(Pt) has values between the second analog reference signal Vu and the first analog reference signal Vl. Then, the touch information signals outputted by the output unit 838 of the sensing signal processor 800 include only the digitized sensor data signals for the touch sensing units SC near the touched position X(Pt). Any signal for the touch sensing units SC where the signal is greater than the second analog reference signal Vu as shown in FIG. 9A or less than the first analog reference signal V1 as shown in FIG. 9B will only be outputted as zero, or some other arbitrary non-touch exhibiting value, by the output unit 838 of the sensing signal processor 800. Accordingly, an external device receiving the touch information signals easily determines whether and where a touch exists.

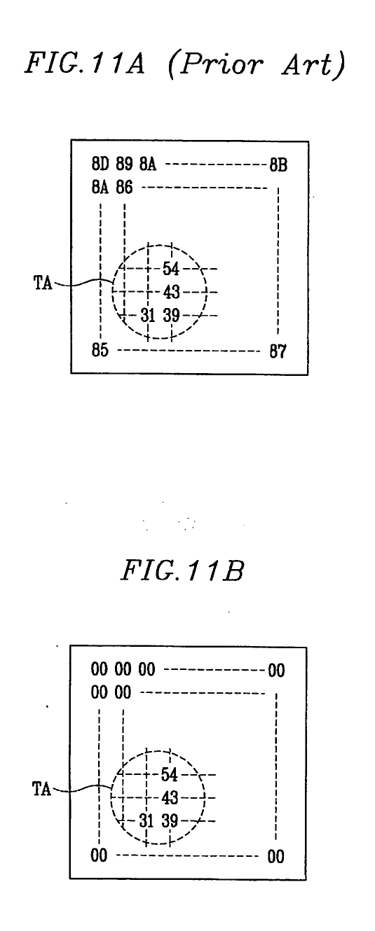

Now, exemplary output signals of the sensing signal processor shown in FIGS. 8-10 will be described in spatial view with reference to FIGS. 11A and 11B.

FIG. 11A shows exemplary output signals of a conventional sensing signal processor, which are arranged in a panel assembly, and FIG. 11B shows exemplary output signals of the exemplary sensing signal processor shown in FIGS. 8-10, which are arranged in a panel assembly of the present invention.

Referring to FIG. 11A, the output signals of the conventional sensing signal processor include the digitized sensor data signals for all the touch sensing units SC. Particularly, the output signals for positions far from the touched position X(Pt) have values similar to the first reference sensor output signal Va. Accordingly, an external device receiving the output signals must apply an algorithm to all of the output signals, whether or not the signals are located even remotely close to a touched position, to determine whether and where a touch exists.

However, the output signals of the sensing signal processor of the present invention include the digitized sensor data signals for touch sensing units SC disposed near the touched position X(Pt) and have zero (“00” in a hexadecimal system) for other touch sensing units SC. Accordingly, the external device need only apply an algorithm to just a few numbers of the output signals and thus the processing time of the external device can be reduced to rapidly determine the touch information.

The external device may be provided in the LCD.

The above-described embodiments can also be applied to other display devices such as organic light emitting diode display, field emission display, etc.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A display device comprising:
a first photosensor receiving ambient light and generating a first sensing signal based on a first amount of received light;
a touch photosensor exposed to the ambient light and generating a second sensing signal based on a second amount of received light; and
a sensing signal processor receiving the first sensing signal and the second sensing signal and selectively outputting the second sensing signal based on the first sensing signal.

2. The display device of claim 1, wherein the sensing signal processor outputs the second sensing signal when the second amount of received light is different from the first amount of received light by a value larger than a first predetermined value.

3. The display device of claim 2, wherein the sensing signal processor outputs the second sensing signal when the second sensing signal is different from the first sensing signal by a value larger than a second predetermined value.

4. The display device of claim 3, wherein the sensing signal processor outputs an output signal having a third predetermined value when the second sensing signal is equal to the first sensing signal or is different from the first sensing signal by a value smaller than the second predetermined value.

5. A display device comprising:
a first photosensor receiving ambient light and equipped light and generating a first sensing signal based on an amount of received light;
a second photosensor blocked from ambient light, receiving the equipped light, and generating a second sensing signal based on an amount of received light;
a touch photosensor receiving the ambient light and the equipped light and generating a third sensing signal based on an amount of received light; and
a sensing signal processor receiving the first sensing signal, the second sensing signal, and the third sensing signal, and selectively outputting the third sensing signal based on the first and the second sensing signals.

6. The display device of claim 5, wherein the sensing signal processor generates a first reference signal based on one of the first sensing signal and the second sensing signal, and generates a second reference signal based on the other of the first sensing signal and the second sensing signal, the second reference signal is smaller than the first reference signal, and the sensing signal processor outputs the third sensing signal when the third sensing signal has a value between the first reference signal and the second reference signal.

7. The display device of claim 6, wherein the sensing signal processor outputs an output signal having a predetermined value when a value of the third sensing signal is out of a range between the first reference signal and the second reference signal.

8. The display device of claim 7, wherein the output signal of the sensing signal processor is zero when the value of the third sensing signal is out of a range between the first reference signal and the second reference signal.

9. The display device of claim 6, wherein the first and the second reference signals are determined by adding or subtracting a predetermined value from the first and the second sensing signals.

10. The display device of claim 9, wherein the first and the second reference signals are determined so that the second sensing signal lies between the first reference signal and the second reference signal.

11. The display device of claim 6, wherein the sensing signal processor comprises:
a calculator generating the first and the second reference signals; and
a comparison unit generating an output signal having a first level and a second level,
wherein the output signal of the comparison unit has the first level when the third sensing signal lies between the first reference signal and the second reference signal and has the second level when the third sensing signal lies outside of a range between the first reference signal and the second reference signal.

12. The display device of claim 11, wherein the comparison unit comprises:
a first comparator having a non-inverting terminal supplied with the first reference signal and an inverting terminal supplied with the third sensing signal; and
a second comparator having a non-inverting terminal supplied with the third sensing signal and an inverting terminal supplied with the second reference signal.

13. The display device of claim 12, wherein the first and the second comparators have a common output.

14. The display device of claim 13, wherein the sensing signal processor further comprises:
an analog-to-digital converter converting the first sensing signal, the second sensing signal, and the third sensing signal into a first digital sensing signal, a second digital sensing signal, and a third digital sensing signal, respectively; and
a digital-to-analog converter connected between the calculator and the comparison unit and analog converting the first and the second reference signals supplied from the calculator.

15. The display device of claim 14, wherein the sensing signal processor further comprises a sensing signal regulator parallel-to-serial converting the first to the third sensing signals to be applied to the analog-to-digital converter.

16. The display device of claim 14, wherein the sensing signal processor further comprises an output unit selectively outputting the third sensing signal in response to the output signal of the comparison unit.

17. The display device of claim 16, wherein the output unit comprises a plurality of AND gates and each of the AND gates has a first input terminal coupled with an output terminal of the analog-to-digital converter and a second input terminal supplied with the output signal of the comparison unit.

18. The display device of claim 17, wherein the output unit outputs the third sensing signal when the output signal of the comparison unit has the first level and outputs a predetermined value when the output signal of the comparison unit has the second level.

19. The display device of claim 18, wherein the output unit outputs a zero value when the output signal of the comparison unit has the second level.

20. The display device of claim 5, further comprising a plurality of pixels displaying images and disposed in a display area, wherein the first photosensor and the touch photosensor are disposed in the display area and the second photosensor is disposed out of the display area.

21. The display device of claim 5, wherein the first, second, and touch photosensors comprise amorphous silicon or polysilicon thin film transistors.

22. A method of processing sensing signals of a display device, the method comprising:
generating a first sensing signal based on ambient light and equipped light;
generating a second sensing signal based on the equipped light;
generating a third sensing signal based on received light according to a touch; and
selectively outputting the third sensing signal based on the first and the second sensing signals.

23. The method of claim 22, wherein selectively outputting the third sensing signal comprises:
generating a first reference signal and a second reference signal lower than the first reference signal based on the first and the second sensing signals;
comparing the third sensing signal with the first and the second reference signals; and
outputting a signal having a predetermined value when the third sensing signal lies out of a range between the first reference signal and the second reference signal.

24. The method of claim 23, wherein selectively outputting the third sensing signal further comprises:
outputting the third sensing signal when the third sensing signal lies between the first reference signal and the second reference signal.

25. The method of claim 24, further comprising:
determining the first and the second reference signals so that the second sensing signal lies between the first reference signal and the second reference signal.

26. A sensing signal processor comprising:
a sensing signal receiving portion receiving at least a first sensing signal, a second sensing signal, and a third sensing signal;
a sensing signal extractor converting the first sensing signal and the second sensing signal into first and second reference signals; and,
an output unit outputting the third sensing signal when the third sensing signal lies between the first and second reference signals, and outputting a constant value when the third sensing signal lies outside a range between the first and second reference signals.

27. The sensing signal processor of claim 26, further comprising a comparison unit within the sensing signal extractor, the comparison unit comparing an output of the sensing signal receiving portion with the first and second reference signals, wherein the comparison unit outputs a first level when the third sensing signal lies between the first and second reference signals, and outputs a second level when the third sensing signal lies outside a range between the first and second reference signals.

28. The sensing signal processor of claim 27, wherein the output unit outputs the third sensing signal when the output signal of the comparison unit has the first level and outputs the constant value when the output signal of the comparison unit has the second level.

29. The display device of claim 28, wherein the constant value is zero.

30. A display device comprising:
a touch sensing circuit for sensing a touch and outputting a sensing signal, and
a sensing signal processor receiving the sensing signal and comparing the sensing signal to first and second reference signals, wherein the sensing signal processor outputs the sensing signal when the sensing signal lies within a range between the first and second reference signals, and outputs a predetermined constant value when the sensing signal lies outside a range between the first and second reference signals.

31. The display device of claim 30, further comprising a first reference sensing circuit and a second reference sensing circuit.

32. The display device of claim 31, wherein the first reference sensing circuit lies within a display area of the display device, and the second reference sensing circuit lies outside the display area of the display device.
